(19) United States
(12) Patent Application Publication
(10) Pub. No.: US 2024/0331900 A1
(43) Pub. Date: Oct. 3, 2024

(54) INSULATOR-COATED SOFT MAGNETIC POWDER, MAGNETIC POWDER CORE, MAGNETIC ELEMENT, AND ELECTRONIC DEVICE

(71) Applicant: SEIKO EPSON CORPORATION, TOKYO (JP)

(72) Inventor: Momoko WAKABAYASHI, Hachinohe-shi (JP)

(21) Appl. No.: 18/609,572

(22) Filed: Mar. 19, 2024

(30) Foreign Application Priority Data
Mar. 23, 2023 (JP) 2023-046396
Dec. 27, 2023 (JP) 2023-220619

(51) Int. Cl. H01F 1/20

(52) U.S. Cl. CPC H01F 1/20

(57) ABSTRACT

An insulator-coated soft magnetic powder includes a soft magnetic powder and an insulating coating film covering the particle surface of the soft magnetic powder and containing a compound having a hydrophobic functional group derived from a coupling agent. The soft magnetic powder has an average particle size of from 2.0 μm to 25.0 μm. The soft magnetic powder has a specific surface area of from 0.05 m²/g to 0.60 m²/g. A ratio A/S is from 3000 to 20000, where S [m²/g] is the specific surface area and A [ppm] is the oxygen content of the soft magnetic powder.

The present application is based on, and claims priority from JP Application Serial Number 2023-046396, filed Mar. 23, 2023, and JP Application Serial Number 2023-220619, filed Dec. 27, 2023, the disclosures of which are hereby incorporated by reference herein in its entirety.

### BACKGROUND

### 1. Technical Field

The present disclosure relates to an insulator-coated soft magnetic powder, a magnetic powder core, a magnetic element, and an electronic device.

### 2. Related Art

JP 2021-95629 A discloses a soft magnetic material including first soft magnetic particles and second soft magnetic particles having an average particle size larger than that of the first soft magnetic particles, the first soft magnetic particles being particles having a non-polar hydrocarbon group or a hydrocarbon group having a linear portion with 6 or more carbons on the surface. Examples of the non-polar hydrocarbon group include a cyclic hydrocarbon group such as an aryl group and a phenyl group. In such a soft magnetic material, the interaction between the first soft magnetic particles and the binder that binds the soft magnetic material can be reduced to improve the flowability of the soft magnetic particles during pressure molding.

In the soft magnetic particles described in JP 2021-95629 A, by introducing a non-polar hydrocarbon group or a hydrocarbon group having a linear portion with 6 or more carbons, the interaction with the binder is reduced, and the flowability at the time of pressure molding is increased. In a magnetic element containing soft magnetic powder, a reduction in iron loss is desirable. As part of the effort to achieve the foregoing, people are making soft magnetic particles smaller. When making soft magnetic particles smaller, the specific surface area increases, and thus the amount of the binder used at the time of pressure molding needs to be increased. However, when the amount of the binder used increases, the space factor of the soft magnetic particles decreases relatively. As a result, the density of green compact decreases, and the magnetic properties also deteriorate. Meanwhile, when the amount of the binder used decreases, the mechanical strength of the green compact decreases.

The situation above presents the challenge of realizing an insulator-coated soft magnetic powder having both density of green compact and mechanical strength of green compact even when the soft magnetic powder has a large specific surface area.

### SUMMARY

An insulator-coated soft magnetic powder according to an application example of the present disclosure includes
a soft magnetic powder, and
an insulating coating film covering the particle surface of the soft magnetic powder and containing a compound having a hydrophobic functional group derived from a coupling agent, wherein
the soft magnetic powder has an average particle size of from 2.0 μm to 25.0 μm,
the soft magnetic powder has a specific surface area of from 0.05 m²/g to 0.60 m²/g, and
a ratio A/S is from 3000 to 20000, where S [m²/g] is the specific surface area and A [ppm] is the oxygen content of the soft magnetic powder.

A magnetic powder core according to an application example of the present disclosure includes the insulator-coated soft magnetic powder according to an application example of the present disclosure.

A magnetic element according to an application example of the present disclosure includes the magnetic powder core according to an application example of the present disclosure.

An electronic device according to an application example of the present disclosure includes the magnetic element according to an application example of the present disclosure.

### BRIEF DESCRIPTION OF THE DRAWINGS

FIG. 1 is a cross-sectional view schematically illustrating a particle of an insulator-coated soft magnetic powder according to an embodiment.

FIG. 2 is a process diagram for explaining a method for producing the insulator-coated soft magnetic powder.

FIG. 3 is a plan view schematically illustrating a toroidal coil component.

FIG. 4 is a transparent perspective view schematically illustrating a closed magnetic circuit coil component.

FIG. 5 is a perspective view illustrating a portable personal computer that is an electronic device including a magnetic element according to an embodiment.

FIG. 6 is a plan view illustrating a smart phone that is an electronic device including the magnetic element according to an embodiment.

FIG. 7 is a perspective view illustrating a digital still camera that is an electronic device including the magnetic element according to an embodiment.

### DESCRIPTION OF EMBODIMENTS

Hereinafter, an insulator-coated soft magnetic powder, a magnetic powder core, a magnetic element, and an electronic device according to an aspect of the present disclosure will be described in detail with reference to preferred embodiments illustrated in accompanying drawings.

### 1. Insulator-Coated Soft Magnetic Powder

First, an insulator-coated soft magnetic powder according to an embodiment will be described. FIG. 1 is a cross-sectional view schematically illustrating a particle of an insulator-coated soft magnetic powder 1 according to an embodiment. Note that, in the following description, a particle of the insulator-coated soft magnetic powder 1 is also referred to as an “insulator-coated soft magnetic particle 4”.

The insulator-coated soft magnetic particle 4 illustrated in FIG. 1 includes a soft magnetic particle 2 and an insulating coating film 3 provided at the surface of the soft magnetic particle 2. Of which, the soft magnetic particle 2 contains a soft magnetic material which will be described later. The insulating coating film 3 covers the surface of the soft magnetic particle 2 and has insulating property. Note that, the term “covering” in the present specification is a concept that includes both a state of the entire surface of the soft magnetic particle 2 being covered and a state of a part of the surface of the soft magnetic particle 2 being covered. In the following description, soft magnetic particles 2 are also collectively referred to as “soft magnetic powder”.

As will be described later, the insulator-coated soft magnetic particle 4 has excellent moisture resistance, and a decrease in the insulating property and flowability of the insulator-coated soft magnetic particle 4 due to moisture absorption is suppressed. For this reason, in a green compact obtained by compacting the insulator-coated soft magnetic powder 1, even when moisture absorption occurs, the insulating property among the insulator-coated soft magnetic particles 4 is good and a high filling property can be achieved, which results in a high green density. As such, the resulting magnetic powder core has good withstand voltage and magnetic properties.

### 1.1. Soft Magnetic Particle

### 1.1.1. Composition of Soft Magnetic Material

The soft magnetic particle 2 is composed of a soft magnetic material. Examples of the soft magnetic material include a material containing at least one of Fe, Ni, or Co as a main component, that is, a material containing one or more of these elements in an atomic ratio of 50% or greater. In addition to these elements serving as the main components, the soft magnetic material may also contain at least one element selected from the group consisting of Cr, Nb, Cu, Al, Mn, Mo, Si, Sn, B, C, P, Ti, and Zr, depending on the target property. The soft magnetic material may also contain unavoidable impurities as long as the effects of the present embodiment are not impaired. Unavoidable impurities are impurities that are unintentionally mixed along with the raw materials or during production. The unavoidable impurities include all elements other than the above-described elements, and examples thereof include O, N, S, Na, Mg, and K.

Specific examples of the soft magnetic material include Fe—Si alloys such as silicon steel, Fe—Si—Al alloys such as Sendust, as well as Fe alloys such as Fe—Ni alloys, Fe—Co alloys, Fe—Ni—Co alloys, Fe—Si—B alloys, Fe—Si—B—C alloys, Fe—Si—B—Cr—C alloys, Fe—Si—Cr alloys, Fe—B alloys, Fe—P—C alloys, Fe—Co—Si—B alloys, Fe—Si—B—Nb alloys, Fe—Si—B—Nb—Cu alloys, Fe—Zr—B alloys, Fe—Cr alloys, and Fe—Cr—Al alloys, Ni alloys such as Ni—Si—B alloys and Ni—P—B alloys, and Co alloys such as Co—Si—B alloys.

By using the soft magnetic material having such a composition, the resulting insulator-coated soft magnetic particle 4 can have high magnetic properties, such as permeability and magnetic flux density, as well as low coercivity.

The content of the above-described main component in the soft magnetic material is preferably 50% or greater, and more preferably 70% or greater in terms of atomic ratio. This makes it possible to particularly improve the magnetic properties of the insulator-coated soft magnetic particle 4, such as the permeability and the magnetic flux density.

The structure constituting the soft magnetic material is not limited, and may be any of a crystalline structure, an amorphous structure, and a microcrystalline (nanocrystalline) structure. Among them, the soft magnetic material preferably contains an amorphous or microcrystalline structure. By including the foregoing, the coercivity decreases, which contributes to a reduction in the hysteresis loss of magnetic element. Note that, in the soft magnetic material, structures of different crystallinities may be present at the same time.

Examples of an amorphous material and a microcrystalline material include Fe alloys such as Fe—Si—B alloys, Fe—Si—B—C alloys, Fe—Si—B—Cr—C alloys, Fe—Si—Cr alloys, Fe—B alloys, Fe—P—C alloys, Fe—Co—Si—B alloys, Fe—Si—B—Nb alloys, Fe—Si—B—Nb—Cu alloys, and Fe—Zr—B alloys, Ni alloys such as Ni—Si—B alloys and Ni—P—B alloys, and Co alloys such as Co—Si—B alloys.

The composition of the soft magnetic material is identified by the following analysis method.

Examples of the analysis method include Iron and Steel—Atomic Absorption Spectrometric Method specified in JIS G 1257:2000, Iron and Steel—ICP Emission Spectrometric Method specified in JIS G 1258:2007, Iron and Steel—Method for Spark Discharge Atomic Emission Spectrometric Analysis specified in JIS G 1253:2002, Iron and Steel—Method For X-Ray Fluorescence Spectrometric Analysis specified in JIS G 1256:1997, and Weight/Titration/Absorption Spectroscopy specified in JIS G 1211 to G 1237.

Specifically, solid-state emission spectrometers available from SPECTRO Analytical Instruments, in particular the spark discharge emission spectrometer LAVMB08A of the model SPECTROLAB, and an ICP device CIROS120 available from Rigaku Corporation may be used.

In particular, the oxygen stream combustion (high-frequency induction heating furnace combustion)—infrared absorption method specified in JIS G 1211: 2011 is also used to identify carbon (C) and sulfur (S). Specifically, a carbon/sulfur analyzer CS-200 available from LECO Corporation may be used.

Further, in particular, the iron and steel-nitrogen quantification method specified in JIS G 1228:1997 and the general rule of oxygen quantification method for metallic materials specified in JIS Z 2613:2006 are used to identify nitrogen (N) and oxygen (O). Specifically, TC-300/EF-300, an oxygen/nitrogen analyzer available from LECO Corporation, may be used.

### 1.1.2. Particle Size Distribution

In the volume-based particle size distribution of the soft magnetic powder, the average particle size of the soft magnetic powder is preferably from 2.0 μm to 25.0 μm, more preferably from 3.0 μm to 15.0 μm, and even more preferably from 4.0 μm to 10.0 μm, where the average particle size is the particle size at a cumulative frequency of 50%.

When the average particle size of the soft magnetic powder is within the above range, the path of intra-particle eddy currents of the soft magnetic particle 2 becomes short, making it possible to sufficiently reduce the eddy current loss of magnetic element in a high frequency region. In addition, when the average particle size of the soft magnetic powder is within the above range, the filling property during compacting becomes high, making it possible to improve the density and mechanical strength of green compact as well as magnetic properties such as the permeability and the saturation magnetic flux density.

Note that, when the average particle size of the soft magnetic powder is less than the lower limit value described above, aggregation is likely to occur, making it difficult to form the insulating coating film 3, and leading to a deterioration in the filling property during compacting as well as a decrease in the density, mechanical strength, magnetic properties, and the like of the green compact. Meanwhile, when the average particle size of the soft magnetic powder exceeds the upper limit value, the path of intra-particle eddy currents becomes long, leading to an increase in the eddy current loss due to intra-particle eddy currents. In addition, the density and mechanical strength of the green compact tend to decrease.

The volume-based particle size distribution of the soft magnetic powder can be measured using, for example, a laser diffraction particle size distribution analyzer.

### 1.1.3. Specific Surface Area

The specific surface area of the soft magnetic powder is set to from 0.05 [m²/g] to 0.60 [m²/g], preferably from 0.10 [m²/g] to 0.50 [m²/g], and more preferably from 0.15 [m²/g] to 0.40 [m²/g]. When the specific surface area is within the above range, the filling property of the soft magnetic powder during compacting becomes high, and the occupancy of the insulating coating film 3 in the green compact can be optimized. As a result, the density and mechanical strength of the green compact can be increased, and the permeability of the green compact can be increased.

Note that, when the specific surface area is less than the lower limit value, the contact area between the soft magnetic powder and the binder decreases, and the mechanical strength of the green compact decreases. Meanwhile, when the specific surface area exceeds the above upper limit value, the filling property during compacting decreases, and the density, mechanical strength, magnetic properties, and the like of the green compact decrease.

The specific surface area of the soft magnetic powder is obtained by the BET method. Examples of the specific surface area measuring device include a BET specific surface area measuring device HM1201-010 available from Mountech Co., Ltd., and the amount of specimen is set to 5 g.

### 1.1.4. Average Circularity

The average circularity of the soft magnetic powder is preferably from 0.75 to 1, more preferably from 0.80 to 1, and even more preferably from 0.85 to 1. In this way, even when the particle size of the soft magnetic powder is small, the particles roll easily, and the filling state can be brought close to close-packing. In addition, since the mechanical strength of the green compact can be ensured even when the amount of the insulating coating film 3 used is reduced, the density and the permeability of the green compact can be easily increased.

Note that, when the average circularity is less than the lower limit value, the flowability of the soft magnetic powder decreases, and the filling rate decreases.

The average circularity of the soft magnetic powder is measured as follows.

First, an image (secondary electron image) of the soft magnetic powder is captured using a scanning electron microscope (SEM). Next, the captured image is read by image processing software. The image processing software used may be, for example, image analysis type particle size distribution measurement software “Mac-View” available from Mountech Co., Ltd. Note that the imaging magnification is adjusted so that 50 to 100 particles are captured in one image. Then, a plurality of images are captured so as to obtain a total of 300 or more particle images.

Next, using software, the circularities of 300 or more particle images are calculated, and an average value thereof is obtained. The obtained average value is the average circularity of the soft magnetic powder. Note that, circularity e is calculated using the following equation, where e represents circularity, s represents the area of a particle image, and L represents the perimeter of a particle image.

$$e = 4 Π s / {L}^{2}$$

### 1.1.5. Oxygen Content

The oxygen content of the soft magnetic powder is preferably from 200 ppm to 5000 ppm, more preferably from 400 ppm to 4000 ppm, and even more preferably from 800 ppm to 3500 ppm, in terms of mass ratio. When the oxygen content is within the above range, the adhesion between the soft magnetic particle 2 and the insulating coating film 3 can be increased. Since the insulating coating film 3 contains the compound derived from a coupling agent, when the oxygen content of the soft magnetic particle 2 is within the above range, the bonding property between the coupling agent and the surface of the soft magnetic particle 2 can be improved. Accordingly, even when the coverage ratio of the insulating coating film 3 is low, the affinity between the insulator-coated soft magnetic powder 1 and the binder can be increased, and the mechanical strength of the green compact can be increased.

Note that, when the oxygen content is less than the lower limit value, the oxide film present on the surface of the soft magnetic particle 2 becomes thin. As such, the bonding between the soft magnetic particle 2 and the insulating film 3 becomes weak, leading to a potential decrease in the mechanical strength of the green compact. Meanwhile, when the oxygen content exceeds the upper limit value, the oxide film becomes thick. As such, the occupancy of the soft magnetic particle 2 in the green compact decreases, leading to a potential decrease in magnetic properties such as permeability.

The oxygen content of the soft magnetic powder is measured, for example, in accordance with the General Rules for Determination of Oxygen in Metallic Materials specified in JIS Z 2613:2006. Specifically, TC-300/EF-300, an oxygen/nitrogen analyzer available from LECO Corporation, and ONH836, an oxygen/nitrogen/hydrogen analyzer available from LECO Corporation, and the like may be used.

1.1.6. Oxygen Content A with Respect to Specific Surface Area S

The oxygen content of the soft magnetic powder is represented by A, and the specific surface area of the soft magnetic powder is represented by S. The ratio of the oxygen content A to the specific surface area S of the soft magnetic powder, or A/S, is set to from 3000 to 20000, preferably from 4000 to 15000, and more preferably from 5000 to 13000. When the ratio A/S is within the above range, the density, mechanical strength, and permeability of the green compact can be optimized. In particular, even when the soft magnetic powder has a large specific surface area S, the mechanical strength of the green compact can be increased. This is because the oxygen content A is optimized with respect to the specific surface area S to ensure the bonding force between the soft magnetic particle 2 and the insulating coating film 3.

Note that, when the ratio A/S is less than the lower limit value, the oxygen content A with respect to the specific surface area S is too low. This results in a weak bonding between the soft magnetic particle 2 and the insulating coating film 3 as well as a decrease in the mechanical strength of the green compact. Meanwhile, when the ratio A/S exceeds the upper limit value, the oxygen content A with respect to the specific surface area S is too high. This results in a decrease in the occupancy of the soft magnetic powder in the green compact, which in turn causes a decrease in density and permeability.

### 1.2. Insulating Coating Film

The insulating coating film 3 covers the surface of the soft magnetic particle 2. The insulating coating film 3 illustrated in FIG. 1 contains a compound derived from a coupling agent having a hydrophobic functional group.

### 1.2.1. Constituent Material

The insulating coating film 3 is formed by a reaction of a coupling agent having a hydrophobic functional group at the surface of the soft magnetic particle 2. Therefore, the insulating coating film 3 contains a compound derived from the coupling agent having a hydrophobic functional group and exhibits properties derived from the hydrophobic functional group.

Examples of the hydrophobic functional group include a saturated hydrocarbon group, a cyclic structure-containing group, a fluoroalkyl group, a fluoroaryl group, a nitro group, an acyl group, and a cyano group. These groups impart good hydrophobicity to the insulating coating film 3.

Among these groups, the hydrophobic functional group is preferably a hydrocarbon group, more preferably a saturated hydrocarbon group, and even more preferably a linear alkyl group having from 1 to 6 carbons. This allows these groups to impart particularly high hydrophobicity to the insulating coating film 3. As such, the resulting insulator-coated soft magnetic powder 1 has excellent flowability and good filling property during compacting even in a humid environment. Note that, when the number of carbons exceeds the upper limit value, it is difficult to achieve a state in which adjacent long-chain alkyl groups are arranged regularly. That is, the arrangement of adjacent long-chain alkyl groups may be disrupted. This may lead to a decrease in the hydrophobicity of the insulating coating film 3.

The hydrophobic functional group may be a cyclic structure-containing group. The cyclic structure-containing group contains a cyclic structure and imparts particularly high hydrophobicity to the insulating coating film 3. In addition, a cyclic structure has high stability, and thus good hydrophobicity can be maintained even after heating. As such, the resulting insulator-coated soft magnetic powder 1 has excellent flowability and good filling property during compacting even in a humid environment.

Examples of the cyclic structure-containing group include an aromatic hydrocarbon group, an alicyclic hydrocarbon group, and a cyclic ether group.

The aromatic hydrocarbon group is a residue obtained by removing a hydrogen atom from aromatic hydrocarbon, and preferably has from 6 to 20 carbons. Examples of the aromatic hydrocarbon group include an aryl group, an alkylaryl group, an aminoaryl group, and a halogenated aryl group. Examples of the aryl group include a phenyl group, a tolyl group, a xylyl group, a naphthyl group, and an indenyl group. Examples of the alkylaryl group include a benzyl group, a methylbenzyl group, a phenethyl group, a methylphenethyl group, and a phenylbenzyl group. Note that the aromatic hydrocarbon group may be substituted with a substituent such as an alkyl group having from 1 to 3 carbons.

The alicyclic hydrocarbon group is a residue obtained by removing a hydrogen atom from alicyclic hydrocarbon, and preferably has from 3 to 20 carbons. Examples of the alicyclic hydrocarbon group include a cycloalkyl group and a cycloalkylalkyl group. Examples of the cycloalkyl group include a cyclopropyl group, a cyclobutyl group, a cyclopentyl group, and a cyclohexyl group. Examples of the cycloalkylalkyl group include a cyclopentylmethyl group and a cyclohexylmethyl group. The alicyclic hydrocarbon group may be substituted with a substituent such as an alkyl group having from 1 to 3 carbons.

Examples of the cyclic ether group include an epoxy group, a 3,4-epoxycyclohexyl group, and an oxetanyl group. The cyclic ether group may be substituted with a substituent such as an alkyl group having from 1 to 3 carbons.

The hydrocarbon group and the cyclic structure-containing group have good affinity with the binder used during compacting. As such, the bonding force between the insulator-coated soft magnetic powder 1 and the binder increases, and the mechanical strength of the green compact can be increased. In addition, the amount of the binder used can be reduced while the mechanical strength of the green compact is maintained, making it possible to increase the occupancy of the soft magnetic powder in the green compact.

The hydrophobic functional group may also be a fluoroalkyl group or a fluoroaryl group. These groups impart particularly high hydrophobicity to the insulating coating film 3. In a fluoroalkyl group having a fluorine atom or a fluoroaryl group having a fluorine atom, surface tension resulting from the fluorine atom is low, which leads to excellent hydrophobicity. As such, the resulting insulator-coated soft magnetic powder 1 has excellent flowability and good filling property during compacting even in a humid environment.

The fluoroalkyl group is an alkyl group having from 1 to 16 carbons with substitution of one or more fluorine atoms or a cycloalkyl group having from 3 to 16 carbons with substitution of one or more fluorine atoms. In particular, the fluoroalkyl group is preferably a perfluoroalkyl group.

The fluoroaryl group is an aryl group having from 6 to 20 carbons with substitution of one or more fluorine atoms. In particular, the fluoroaryl group is preferably a perfluoroaryl group.

### 1.2.2. Average Thickness

The average thickness of the insulating coating film 3, although not limited, is preferably from 0.1 nm to 50 nm, more preferably from 0.5 nm to 30 nm, and even more preferably from 1 nm to 20 nm. This ensures the film thickness necessary to maintain the insulating coating film 3, making it possible to sufficiently achieve the above effects. At the same time, this can suppress an increase in the occupancy of the insulating coating film 3 in the insulator-coated soft magnetic powder 1.

The average thickness of the insulating coating film 3 can be specified by, for example, qualitative and quantitative analysis in a depth direction using X-ray photoelectron spectroscopy and ion sputtering in combination. Specifically, the concentration of components derived from the coupling agent is examined along a depth direction. The region having a relatively high concentration of components derived from the coupling agent is taken as the average thickness of the insulating coating film 3. Specifically, when the concentration changes in the vicinity of the boundary between the insulating coating film 3 and the soft magnetic particle 2, the position corresponding to half the amount of change in concentration, that is, the midpoint between the concentration on the insulating coating film 3 side and the concentration on the soft magnetic particle 2 side, is regarded as the boundary, and the thickness on the surface side of the boundary may be taken as the average thickness of the insulating coating film 3.

### 1.2.3. Coverage Ratio

The coverage ratio of the insulating coating film 3 is the ratio of the area of the surface of the soft magnetic particle 2 covered by the insulating coating film 3 to the area of the entire surface of the soft magnetic particle 2. The coverage ratio of the insulating coating film 3 is preferably from 20% to 120%, more preferably from 30% to 110%, and even more preferably from 40% to 100%. Thia can sufficiently ensure insulation between the soft magnetic particles 2 by the insulating coating film 3, and reduce the iron loss of the green compact. In addition, this can further increase the affinity between the insulator-coated soft magnetic powder 1 and the binder, which can in turn increase the mechanical strength of the green compact, or reduce the amount of the binder to be used while maintaining the mechanical strength of the green compact. Note that the state in which the coverage ratio exceeds 100% is a state in which two or more molecules of the compound derived from the coupling agent overlap on a part of the surface of the soft magnetic particle 2.

Note that, when the coverage ratio of the insulating coating film 3 is less than the lower limit value, the mechanical strength of the green compact may decrease. Meanwhile, when the coverage ratio of the insulating coating film 3 exceeds the upper limit value, the compound derived from the coupling agent becomes excessive, leading to a potential decrease in the density and the permeability of the green compact.

The coverage ratio of the insulating coating film 3 can be calculated from the amount of the compound contained in the insulator-coated soft magnetic powder 1, the amount of the soft magnetic powder, the minimum coverage area of the coupling agent, and the specific surface area of the soft magnetic powder.

### 1.3. Water Content

The water content of the insulator-coated soft magnetic powder 1, although not limited, is preferably from 30 ppm to 500 ppm, more preferably from 40 ppm to 300 ppm, and even more preferably from 50 ppm to 200 ppm. When the water content of the insulator-coated soft magnetic powder 1 is within the above range, a decrease in flowability due to adsorption of moisture is suppressed. As such, the resulting insulator-coated soft magnetic powder 1 has excellent flowability. In addition, when the water content is within the above range, susceptibility to charging of the insulator-coated soft magnetic powder 1 can be kept within an appropriate range, and a decrease in flowability due to charging can be suppressed. In addition, when the water content is within the above range, rusting of the soft magnetic particle 2 due to moisture can be suppressed, and thus deterioration of magnetic properties of the green compact can also be suppressed.

Note that, when the water content is less than the lower limit value, the insulator-coated soft magnetic powder 1 becomes susceptible to charging, leading to a possible decrease in flowability. Meanwhile, when the water content exceeds the upper limit value, flowability may decrease and the soft magnetic particle 2 may rust because the water content of the insulator-coated soft magnetic powder 1 is too much.

The water content of the insulator-coated soft magnetic powder 1 is determined by leaving the insulator-coated soft magnetic powder 1 to be measured in an environment with a temperature of 25° C. and a relative humidity of 50% for one hour or more, and then measuring the water content at 250° C. using the Karl Fischer method. For the measurement, a water content measuring device CA-310 available from Nittoseiko Analytech Co., Ltd. can be used, for example.

### 1.4. Radial Crushing Strength

The insulator-coated soft magnetic powder 1 is mixed with 2 mass % of an epoxy resin and dried at 50° C. for 1 hour, resulting in a granulated powder. The resulting granulated powder is press-molded at a pressure of 294.2 MPa (3 t/cm²), and then heated at 150° C. for 30 minutes to cure the epoxy resin, resulting in a molded article. The radial crushing strength of the resulting molded article is preferably 10 MPa or greater, more preferably 20 MPa or greater, and even more preferably 30 MPa or greater. This makes it possible to realize a magnetic element having high mechanical strength and high reliability. Note that, the upper limit value, while not particularly necessary to be set, is preferably 60 MPa or less, and more preferably 50 MPa or less, from the viewpoint of reducing production inconsistencies.

Note that, the shape of the molded article is a ring shape with an outer diameter of 14 mm, an inner diameter of 8 mm, and a thickness of 3 mm. The radial crushing strength is measured in accordance with the radial crushing strength test method specified in JIS Z 2507:2000. Specifically, the radial crushing strength K is calculated by K=F(D−t)/(Lt²), where K is the radial crushing strength, D is the outer diameter, t is the thickness in the radial direction (half of the difference between the outer diameter and the inner diameter), L is the thickness, and F is the breaking load.

### 2. Method of Producing Insulator-Coated Soft Magnetic Powder

Next, a method for producing the insulator-coated soft magnetic powder 1 will be described.

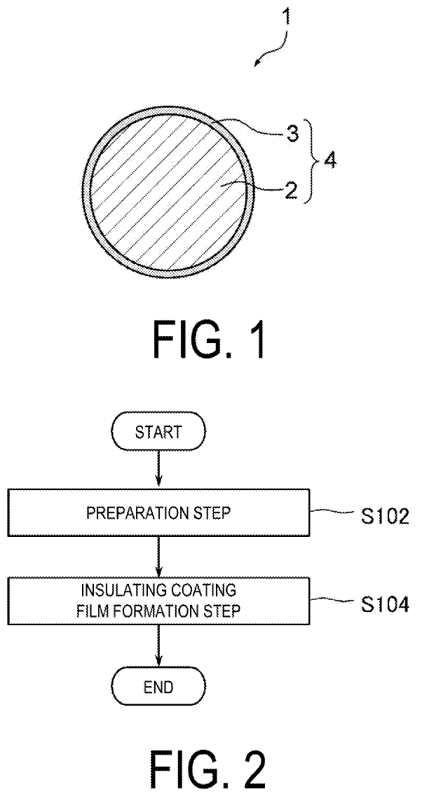

FIG. 2 is a process diagram for explaining a method for producing the insulator-coated soft magnetic powder 1.

The method of producing the insulator-coated soft magnetic powder illustrated in FIG. 2 includes a preparation step S102 and an insulating coating film formation step S104.

### 2.1. Preparation Step

In the preparation step S102, the soft magnetic powder is prepared. The soft magnetic powder may be a powder produced by any method. Examples of the production method include various atomization methods such as water atomization, gas atomization, and rotary water jet atomization, as well as a reduction method, a carbonyl method, and a pulverization method. Among these examples, an atomization method is preferable. That is, the soft magnetic powder is preferably an atomized powder. An atomized powder is fine, has high sphericity, and high production efficiency. Further, in particular, water atomized powder or rotary water jet atomized powder has a thin oxide film on the surface of the powder because it is produced by the contact between a molten metal and water. This oxide film can serve as a base of the insulating coating film 3. Therefore, the adhesion between the soft magnetic particle 2 and the insulating coating film 3 is excellent, and the insulator-coated soft magnetic particles 4 eventually produced have particularly high insulation between the particles. In addition, the fast cooling speed allows for the soft magnetic powder produced to contain an amorphous structure or a microcrystalline structure.

### 2.2. Insulating Coating Film Formation Step

In the insulating coating film formation step S104, a coupling agent having a hydrophobic functional group is reacted with the soft magnetic particles 2. This causes the coupling agent to attach to the surface of the soft magnetic particles 2.

For this operation, the following three operations are the examples.

The first operation includes putting both the soft magnetic particles 2 and the coupling agent into a chamber and then heating the inside of the chamber.

The second operation includes putting the soft magnetic particles 2 into a chamber, and then spraying the coupling agent into the chamber while stirring the soft magnetic particles 2.

The third operation includes putting water, a coupling agent, an alkaline solution such as ammonia or sodium hydroxide, and the soft magnetic particles 2 into a primary alcohol such as methanol, ethanol, or isopropyl alcohol, and then performing stirring, filtering, and drying.

Examples of the coupling agent include a silane coupling agent, a titanium coupling agent, and a zirconium coupling agent.

The following chemical formula is an example of a molecular structure of the silane coupling agent.

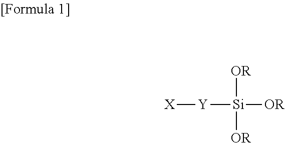

where X is a functional group, Y is a spacer, and OR is a hydrolyzable group. Note that, R is a methyl group or an ethyl group, for example.

Examples of the spacer include an alkylene group, an arylene group, an aralkylene group, and an alkylene ether group.

The hydrolyzable group is, for example, an alkoxy group, a halogen atom, a cyano group, an acetoxy group, or an isocyanate group; among these, in the case of an alkoxy group, hydrolysis yields silanol. The silanol reacts with a hydroxyl group generated at the surface of the soft magnetic particles 2, and the coupling agent adheres to the surface of the soft magnetic particles 2.

At least one such hydrolyzable group may be contained in the coupling agent, but preferably two or more of such hydrolyzable groups are contained, and more preferably three such hydrolyzable groups are contained as illustrated by the above formula. For example, the coupling agent in which the hydrolyzable group is an alkoxy group preferably contains a dialkoxy group, and more preferably contains a trialkoxy group. The coupling agent containing a trialkoxy group reacts with three hydroxyl groups generated at the surface of the soft magnetic particles 2. This results in good adhesion to the soft magnetic particles 2. In addition, the coupling agent containing a trialkoxy group has excellent film-formation property, and thus the resulting insulating coating film 3 has excellent continuity. Such insulating coating film 3 contributes to a further increase in the flowability of the insulator-coated soft magnetic powder 1.

In addition, in the coupling agent containing a trialkoxy group, even when the hydrophobic functional group is thermally decomposed after the insulating coating film 3 is formed, the remaining part can continue to cover the surface of the soft magnetic particles 2. As such, a decrease in hydrophobicity can be suppressed.

Here, examples of the coupling agent having a hydrophobic functional group are presented. Examples of the coupling agent having an aromatic hydrocarbon group include:
phenyltrimethoxysilane represented by Formula (A-1) below:

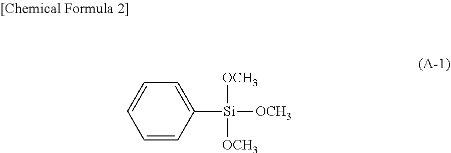 [SMILES: CO[Si](OC)(OC)c1ccccc1]

phenyltriethoxysilane represented by Formula (A-2) below:

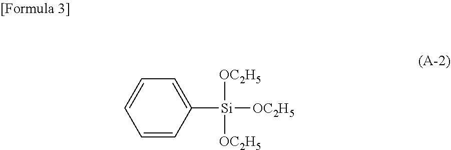 [SMILES: CCO[Si](OCC)(OCC)c1ccccc1]

dimethoxydiphenylsilane represented by Formula (A-3) below:

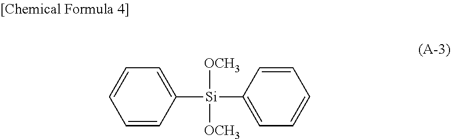 [SMILES: CO[Si](OC)(c1ccccc1)c1ccccc1]

2,2-dimethoxy-1-phenyl-1-aza-2-silacyclopentane represented by Formula (A-4) below:

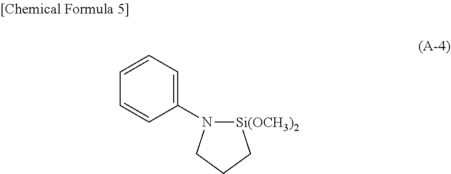

3-phenoxypropyltrichlorosilane represented by Formula (A-11) below:

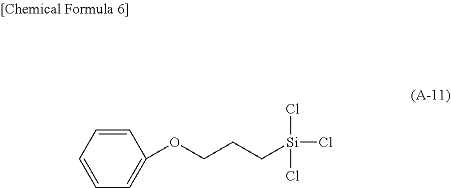 [SMILES: Cl[Si](Cl)(Cl)CCCOc1ccccc1]

phenyltriacetoxysilane represented by Formula (A-12) below:

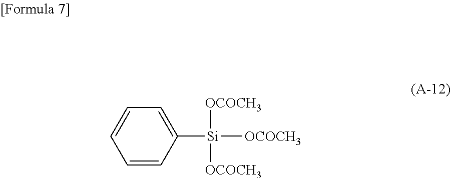

triethoxy(p-tolyl)silane represented by Formula (A-13) below:

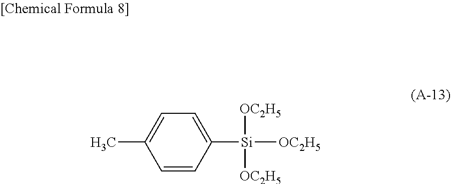 [SMILES: CCO[Si](OCC)(OCC)c1ccc(C)cc1]

p-aminophenyltrimethoxysilane represented by Formula (A-14) below:

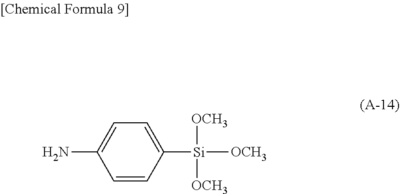 [SMILES: CO[Si](OC)(OC)c1ccc(N)cc1]

m-aminophenyltrimethoxysilane represented by Formula (A-15) below:

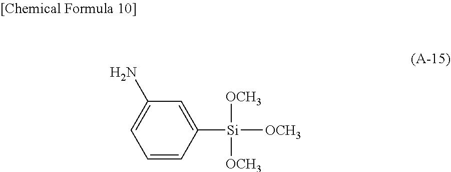 [SMILES: CO[Si](OC)(OC)c1cccc(N)c1]

((chloromethyl)phenylethyl)trimethoxysilane represented by Formula (A-16) below:

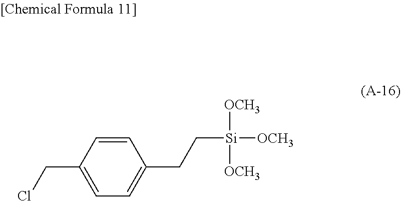 [SMILES: CO[Si](CCc1ccc(CCl)cc1)(OC)OC]

and the like.

Examples of the coupling agent having a cyclic ether group include:
3-glycidoxypropylmethyldimethoxysilane represented by Formula (A-5) below:

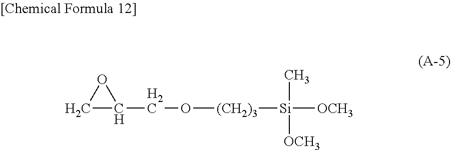

3-glycidoxypropyltrimethoxysilane represented by Formula (A-6) below:

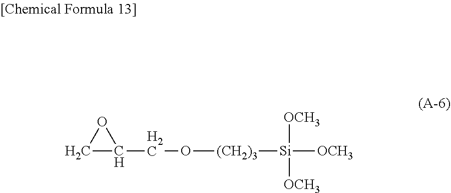

3-glycidoxypropylmethyldiethoxysilane represented by Formula (A-7) below:

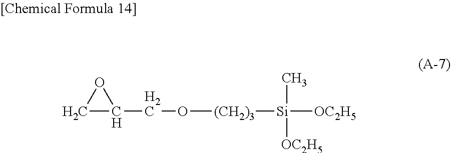

3-glycidoxypropyltriethoxysilane represented by Formula (A-8) below:

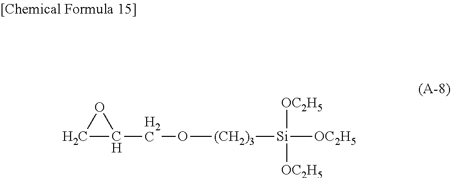

and the like.

Examples of the coupling agent having a fluoroalkyl group include:
trimethoxy(3,3,3-trifluoropropyl)silane represented by Formula (B-1) below:

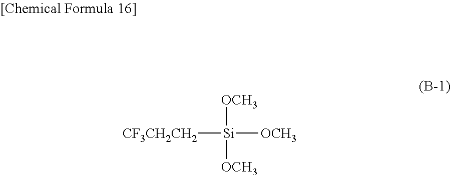

trimethoxy(1H,1H,2H,2H-tridecafluoro-n-octyl)silane represented by Formula (B-2) below:

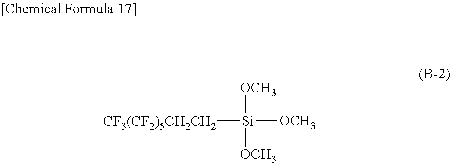

trimethoxy(1H,1H,2H,2H-nonafluorohexyl)silane represented by Formula (B-3) below:

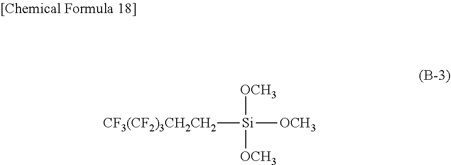

and the like.

Examples of the coupling agent having a fluoroaryl group include:
trimethoxy(11-pentafluorophenoxyundecyl)silane represented by Formula (C-1) below:

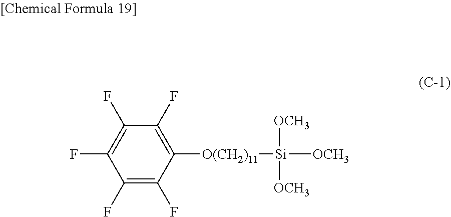

pentafluorophenyldimethylchlorosilane represented by Formula (C-2) below:

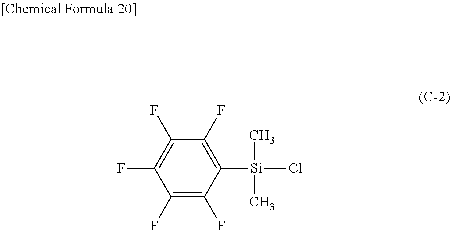

and the like.

The amount of the coupling agent to be added is not limited, but is preferably from 0.01 mass % to 1.00 mass %, and more preferably from 0.05 mass % to 0.50 mass %, with respect to the soft magnetic particles 2.

Further, the coupling agent is supplied into the chamber by a method such as leaving the coupling agent in the chamber or spraying the coupling agent into the chamber.

Thereafter, the soft magnetic particles 2 to which the coupling agent is attached are heated. Thereby, the insulating coating film 3 is formed at the surface of the soft magnetic particles 2, resulting in the insulator-coated soft magnetic powder 1. Moreover, unreacted coupling agent can be removed by heating.

The heating temperature of the soft magnetic particles 2 to which the coupling agent is attached is not limited, but is preferably from 50° C. to 300° C., more preferably from 100° C. to 250° C. The heating time is preferably from 10 minutes to 24 hours, more preferably from 30 minutes to 10 hours. Examples of the atmosphere of the heat treatment include an air atmosphere and an inert gas atmosphere.

### 3. Magnetic Powder Core and Magnetic Element

Next, the magnetic powder core and the magnetic element according to the embodiment will be described.

The magnetic element according to the embodiment can be applied to various magnetic elements having a magnetic core, such as a choke coil, an inductor, a noise filter, a reactor, a transformer, a motor, an actuator, a solenoid valve, and a generator. The magnetic powder core according to the embodiment can be applied to the magnetic core of these magnetic elements.

Hereinafter, two types of coil components will be described as representative examples of the magnetic element.

### 3.1. Toroidal Coil

First, a toroidal coil component which is an example of the magnetic element according to the embodiment will be described.

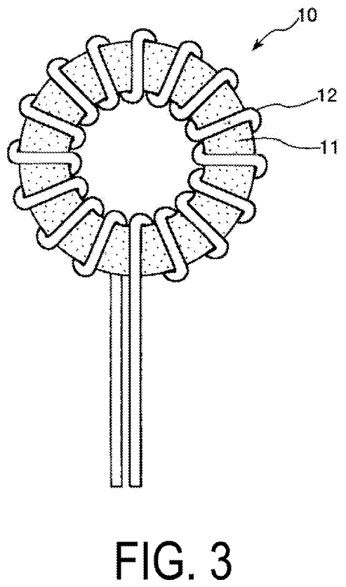

FIG. 3 is a plan view schematically illustrating a toroidal coil component.

A coil component 10 illustrated in FIG. 3 includes a ring-shaped magnetic powder core 11 and a conductive wire 12 wound around the magnetic powder core 11. Such a coil component 10 is generally referred to as a toroidal coil.

The magnetic powder core 11 is obtained by mixing the insulator-coated soft magnetic powder according to the embodiment with a binder, supplying the resulting mixture to a molding die, and performing pressing and molding. The magnetic powder core 11 is a green compact including the insulator-coated soft magnetic powder according to the embodiment, and thus the resulting coil component 10 has both magnetic properties and mechanical strength. Therefore, an electronic device or the like including the coil component 10 can have a high performance and a small size.

Examples of the constituent material of the binder used to prepare the magnetic powder core 11 include organic materials such as silicone-based resin, epoxy-based resin, phenol-based resin, polyamide-based resin, polyimide-based resin, and polyphenylene sulfide-based resin, as well as inorganic materials such as phosphates such as magnesium phosphate, calcium phosphate, zinc phosphate, manganese phosphate, and cadmium phosphate, and silicates such as sodium silicate. Of these, thermosetting polyimide or epoxy-based resins are particularly preferable. These resin materials are easily cured by heating, and are excellent in heat resistance. Therefore, the ease of producing the magnetic powder core 11 and the heat resistance of the magnetic powder core 11 can be increased.

The ratio of the binder to the insulator-coated soft magnetic powder varies slightly depending on the target magnetic properties and mechanical properties of the magnetic powder core 11 to be prepared, the allowable eddy current loss, and the like. The ratio is preferably approximately from 0.3 mass % to 5.0 mass %, more preferably approximately from 0.5 mass % to 3.0 mass %, and even more preferably approximately from 0.7 mass % to 2.0 mass %. This allows the particles of the soft magnetic powder to sufficiently bind to each other, and thus the resulting coil component 10 has excellent magnetic properties. Various additives may be added to the mixture as necessary for any purpose.

Examples of the constituent material of the conductive wire 12 include highly conductive materials such as metal materials including Cu, Al, Ag, Au, and Ni. An insulating film may be provided at the surface of the conductive wire 12 as necessary.

The shape of the magnetic powder core 11 is not limited to the ring shape illustrated in FIG. 3, and may be, for example, a partially notched ring shape, a shape in which the shape in the longitudinal direction is linear, a sheet shape, or a film shape.

The magnetic powder core 11 may contain a soft magnetic powder other than the insulator-coated soft magnetic powder according to the above-described embodiment and/or a non-magnetic powder as necessary.

### 3.2. Closed Magnetic Circuit Coil

Next, a closed magnetic circuit coil component which is an example of the magnetic element according to the embodiment will be described.

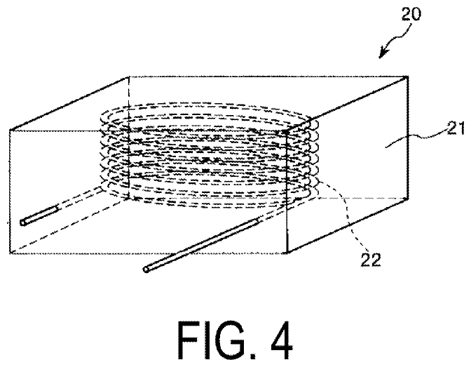

FIG. 4 is a transparent perspective view schematically illustrating a closed magnetic circuit coil component.

The following description of the closed magnetic circuit coil component mainly focuses on differences from the toroidal coil component, and descriptions on similar matters will be omitted.

As illustrated in FIG. 4, a coil component 20 according to the present embodiment is formed by embedding a conductive wire 22 formed in a coil shape inside a magnetic powder core 21. That is, the coil component 20, which is the magnetic element, includes a powder magnetic core 21 containing the above-mentioned insulator-coated soft magnetic powder, and a conductive wire 22 is molded with the powder magnetic core 21. The magnetic powder core 21 has the same configuration as the magnetic powder core 11 described above. As such, the resulting coil component 20 has high magnetic properties and high mechanical strength.

Downsizing of the coil component 20 having such a configuration is relatively easy. Therefore, an electronic device or the like including the coil component 20 can have a high performance and a small size.

With the conductive wire 22 embedded in the magnetic powder core 21, a gap is less likely to be formed between the conductive wire 22 and the magnetic powder core 21. Therefore, vibration caused by magnetostriction of the magnetic powder core 21 can be suppressed, and noise generated due to the vibration can also be suppressed.

Note that, the shape of the magnetic powder core 21 is not limited to the shape illustrated in FIG. 4, and may be a sheet shape, a film shape, or the like.

The magnetic powder core 21 may contain a soft magnetic powder other than the insulator-coated soft magnetic powder according to the above-described embodiment and/or a non-magnetic powder as necessary.

### 4. Electronic Device

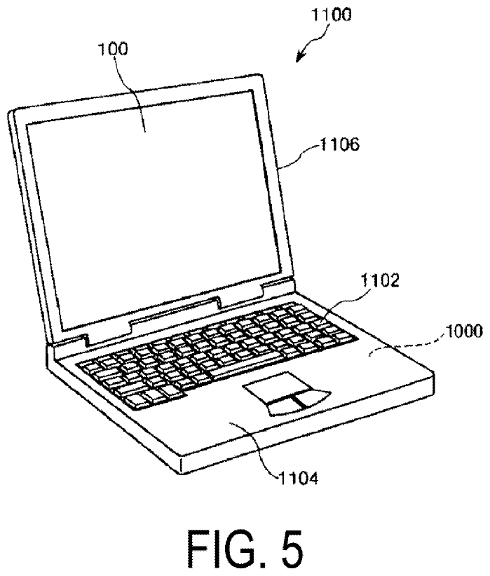

Next, an electronic device including the magnetic element according to the embodiment will be described with reference to FIG. 5 to FIG. 7.

FIG. 5 is a perspective view illustrating a portable personal computer that is an electronic device including the magnetic element according to the embodiment. A personal computer 1100 illustrated in FIG. 5 includes a main body 1104 provided with a keyboard 1102 and a display unit 1106 provided with a display unit 100. The display unit 1106 is rotatably supported via a hinge structure with respect to the main body 1104. A magnetic element 1000 such as a choke coil, an inductor, or a motor for a switching power supply is incorporated in the personal computer 1100.

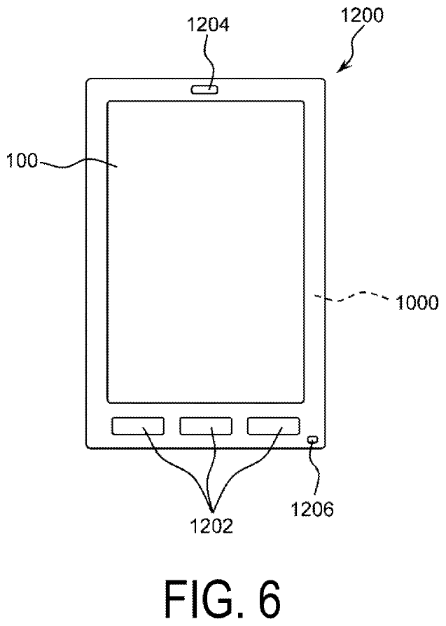

FIG. 6 is a plan view illustrating a smart phone that is an electronic device including the magnetic element according to the embodiment. A smart phone 1200 illustrated in FIG. 6 includes a plurality of operation buttons 1202, an earpiece 1204, and a mouthpiece 1206. The display unit 100 is disposed between the operation buttons 1202 and the earpiece 1204. The magnetic element 1000 such as an inductor, a noise filter, or a motor is incorporated in the smart phone 1200.

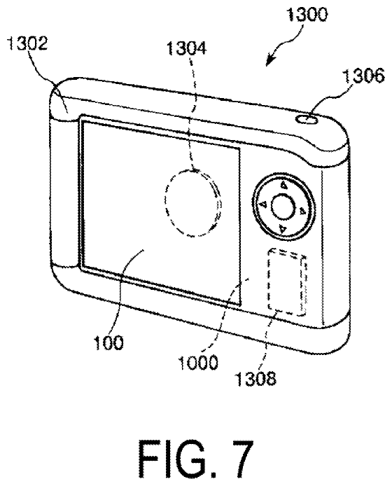

FIG. 7 is a perspective view illustrating a digital still camera that is an electronic device including the magnetic element according to the embodiment. A digital still camera 1300 generates a captured image signal by photoelectrically converting an optical image of a subject using an imaging element such as a charge coupled device (CCD).

The digital still camera 1300 illustrated in FIG. 7 includes the display unit 100 provided at the back surface of a case 1302. The display unit 100 functions as a viewfinder that displays the electronic image of the subject. A light receiving unit 1304 including an optical lens, a CCD, and the like is provided at the front side of the case 1302, that is, on the back side in the drawing.

When the photographer confirms the subject image displayed on the display unit 100 and presses a shutter button 1306, the captured image signal of the CCD at that time is transferred to and stored in a memory 1308. The digital still camera 1300 also incorporates the magnetic element 1000 such as an inductor or a noise filter.

In addition to the personal computer illustrated in FIG. 5, the smart phone illustrated in FIG. 6, and the digital still camera illustrated in FIG. 7, examples of the electronic device according to the embodiment include a mobile phone, a tablet terminal, a timepiece, an ink jet-type ejecting device such as an ink-jet printer, a laptop-type personal computer, a television, a video camera, a video tape recorder, a car navigation device, a pager, an electronic notebook, an electronic dictionary, a calculator, an electronic gaming device, a word processor, a workstation, a videophone, a security monitor, digital binoculars, a POS terminal, a digital thermometer, a blood pressure monitor, a blood glucose meter, an electrocardiogram measuring device, an ultrasonic diagnostic device, a medical device such as an electronic endoscope, a fish finder, various measuring devices, instruments for a vehicle, an aircraft, and a ship, a mobile control devices such as an automobile control device, an aircraft control device, a railroad vehicle control device, and a ship control device, as well as a flight simulator.

As described above, such an electronic device includes the magnetic element according to the embodiment. Accordingly, it is possible to achieve the effects of the magnetic element according to the embodiment, that is, both magnetic properties and mechanical strength, and to achieve high performance and downsizing of the electronic device.

### 5. Effects Achieved by Embodiment Described Above

As described above, the insulator-coated soft magnetic powder 1 according to the present embodiment includes the soft magnetic powder and the insulating coating film 3. The insulating coating film 3 covers the surface of the soft magnetic particles 2 (the particle surface of the soft magnetic powder) and contains a compound derived from a coupling agent having a hydrophobic functional group. The soft magnetic powder has an average particle size of from 2.0 μm to 25.0 μm, and a specific surface area of from 0.05 m²/g to 0.60 m²/g. In addition, the ratio A/S is from 3000 to 20000, where S [m²/g] is the specific surface area of the soft magnetic powder and A [ppm] is the oxygen content in the soft magnetic powder.

Such a configuration yields the insulator-coated soft magnetic powder 1 having both density of green compact and mechanical strength of green compact even when the soft magnetic powder has a large specific surface area.

The oxygen content A in the soft magnetic powder is preferably from 200 ppm to 5000 ppm.

Such a configuration can increase the adhesion between the soft magnetic particles 2 and the insulating coating film 3. Accordingly, the affinity between the insulator-coated soft magnetic powder 1 and the binder can be increased, and the mechanical strength of the green compact can be increased.

Further, the hydrophobic functional group is preferably a hydrocarbon group.

Such a configuration imparts particularly high hydrophobicity to the insulating coating film 3. As such, the resulting insulator-coated soft magnetic powder 1 has excellent flowability and good filling property during compacting even in a humid environment.

Further, the hydrocarbon group is preferably a linear alkyl group having from 1 to 6 carbons.

Such a configuration imparts particularly high hydrophobicity to the insulating coating film 3. As such, the resulting insulator-coated soft magnetic powder 1 has excellent flowability and good filling property during compacting even in a humid environment.

The hydrophobic functional group may be a cyclic structure-containing group.

The cyclic structure-containing group contains a cyclic structure and imparts particularly high hydrophobicity to the insulating coating film 3. In addition, a cyclic structure has high stability, and thus good hydrophobicity can be maintained even after heating. As such, the resulting insulator-coated soft magnetic powder 1 has excellent flowability and good filling property during compacting even in a humid environment.

The coverage ratio of the insulating coating film 3 is preferably from 20% to 120%.

With such a configuration, insulation between the soft magnetic particles 2 by the insulating coating film 3 can be sufficiently ensured, and the iron loss of the green compact can be reduced. In addition, this can further increase the affinity between the insulator-coated soft magnetic powder 1 and the binder, which can in turn increase the mechanical strength of the green compact, or reduce the amount of the binder to be used while maintaining the mechanical strength of the green compact.

In addition, when the insulator-coated soft magnetic powder 1 is mixed with 2 mass % of an epoxy resin, and the resulting mixture is press-molded at a pressure of 294.2 MPa and then heated at 150° C. for 30 minutes to cure the epoxy resin to prepare a molded article, the radial crushing strength of the molded article is preferably 10 MPa or greater.

With such a configuration, the resulting insulator-coated soft magnetic powder 1 can be used to achieve a magnetic element having high mechanical strength and high reliability.

Moreover, the water content measured at 250° C. by the Karl Fischer method is preferably from 30 ppm to 500 ppm.

With a configuration, a decrease in flowability due to moisture adsorption is suppressed, and the resulting insulator-coated soft magnetic powder 1 has excellent flowability. In addition, susceptibility to charging of the insulator-coated soft magnetic powder 1 can be kept within an appropriate range, and a decrease in flowability due to charging can be suppressed.

The magnetic powder core according to the embodiment includes the insulator-coated soft magnetic powder according to the embodiment. As such, the resulting magnetic powder core can be used to realize a magnetic element having both magnetic properties and mechanical strength.

The magnetic element according to the embodiment includes the magnetic powder core according to the embodiment. As such, the resulting magnetic element has both magnetic properties and mechanical strength.

The electronic device according to the embodiment includes the magnetic element according to the embodiment. As such, the resulting electronic device has high performance and is downsized.

The insulator-coated soft magnetic powder, the magnetic powder core, the magnetic element, and the electronic device of the present disclosure have been described above based on the preferred embodiment, but the present disclosure is not limited to the embodiment.

For example, in the embodiment above, the magnetic powder core has been described as an application example of the insulator-coated soft magnetic powder of the present disclosure, but application examples are not limited to the described application example, and may be a magnetic device such as a magnetic fluid, a magnetic head, or a magnetic shielding sheet. In addition, the shapes of the magnetic powder core and the magnetic element are not limited to those illustrated in the drawings and may be any shape.

Moreover, the magnetic powder core and magnetic element according to the present disclosure may have any component added to the embodiment above.

### EXAMPLE

Next, specific examples of the present disclosure will be described.

### 6. Preparation of Insulator-Coated Soft Magnetic Powder

### 6.1. Sample No. 1

First, a soft magnetic powder composed of a soft magnetic material listed in Table 1 was prepared by an atomization method. The composition of the soft magnetic material is presented in Table 1. Further, the average particle size, specific surface area, oxygen content, average circularity, etc. of the soft magnetic powder are as listed in Table 2.

Next, an insulating coating film was formed at the particle surface of the soft magnetic powder. The hydrophobic functional group of the coupling agent used to form the insulating coating film, the number of carbons when the hydrophobic functional group is an alkyl group, and the coverage ratio of the insulating coating film are as listed in Table 2.

The insulator-coated soft magnetic powder of Sample No. 1 was prepared as described above. Thereafter, the water content of the prepared insulator-coated soft magnetic powder was measured. The measurement results are as listed in Table 2.

### 6.2. Samples No. 2 to 26

The insulator-coated soft magnetic powders of Samples No. 2 to 26 were prepared in the same manner as in Sample No. 1 except that the compositions of the insulator-coated soft magnetic powders were changed to those listed in Table 1 and Table 2.

TABLE 1

| Soft Magnetic Material | Composition Formula (Atomic Ratio) |
|---|---|
| Crystalline | Fe_{88.6}Si_{6.7}Cr_{4.7} |
| Amorphous 1 | (Fe_{0.97}Cr_{0.03})₇₆(Si_{0.5}B_{0.5})₂₂C₂ |
| Amorphous 2 | Fe₇₉(Si_{0.3}B_{0.7})₁₉C₂ |

Note that, in Table 2 presented later, among the insulator-coated soft magnetic powders of the sample numbers, those that correspond to the present disclosure are referred to as “Examples”, and those that do not correspond to the present disclosure are referred to as “Comparative Examples”.

Furthermore, the symbols in the chemical formulas listed in Table 2 correspond to the following compounds.
A-1: Phenyltrimethoxysilane
A-6: 3-Glycidoxypropyltrimethoxysilane
B-1: Trimethoxy(3,3,3-trifluoropropyl)silane
C-1: Trimethoxy(ii-pentafluorophenoxyundecyl)silane
D-1: Methyltrimethoxysilane
D-2: Propyltrimethoxysilane
D-3: Hexyltrimethoxysilane
D-4: Octyltrimethoxysilane

### 7. Evaluation of Insulator-Coated Soft Magnetic Powder

### 7.1. Relative Density of Molded Article

First, the insulator-coated soft magnetic powders were each mixed with an epoxy resin serving as a binder and toluene serving as an organic solvent, resulting in mixtures. Note that, the amount of epoxy resin added was 2 parts by mass per 100 parts by mass of insulator-coated soft magnetic powder.

Next, the resulting mixtures were stirred and then dried at 50° C. for 1 hour in an air atmosphere, resulting in dried masses. Next, dried masses were passed through a sieve having an opening of 400 μm to pulverize the dried masses, resulting in granulated powders.

Next, the resulting granulated powders were filled in molding dies, and green compacts were obtained based on the following molding conditions.
Molding method: press molding
Shape of molded article: ring shape
Dimensions of molded article: outer diameter p 14 mm, inner diameter φ8 mm, thickness 3 mm
Molding force: 3 t/cm² (294.2 MPa)

Next, the green compacts were heated at 150° C. for 30 minutes in an air atmosphere to cure the binder. This resulted in ring-shaped molded articles.

Next, the densities of the molded articles were measured. Next, the densities of the molded articles were divided by the true densities of the soft magnetic powders to calculate the relative densities. The calculated relative densities were evaluated based on the following evaluation criteria. The evaluation results are presented in Table 2.
A: A relative density of 67% or greater
B: A relative density of 66% or greater and less than 67%
C: A relative density of 65% or greater and less than 66%
D: A relative density of 64% or greater and less than 65%
E: A relative density of 63% or greater and less than 64%
F: A relative density of less than 63%

### 7.2. Radial Crushing Strength of Molded Article

The radial crushing strengths of the molded articles prepared in the same manner as in 7.1. were measured in accordance with the radial crushing strength test method specified in JIS Z 2507:2000. The calculated radial crushing strengths were evaluated based on the following evaluation criteria. The evaluation results are presented in Table 2.
A: A radial crushing strength of 50 MPa or greater
B: A radial crushing strength of 45 MPa or greater and less than 50 MPa
C: A radial crushing strength of 40 MPa or greater and less than 45 MPa
D: A radial crushing strength of 35 MPa or greater and less than 40 MPa
E: A radial crushing strength of 30 MPa or greater and less than 35 MPa
F: A radial crushing strength of less than 30 MPa

### 7.3. Permeability of Molded Article

The permeabilities of the molded articles prepared in the same manner as in 7.1. were measured. The permeabilities of the molded articles refer to relative magnetic permeabilities, that is, effective permeabilities, obtained from the self-inductance of closed magnetic circuit magnetic core coils produced using the molded articles. For the measurement of permeabilities, an impedance analyzer was used, and the measurement frequency was 100 kHz. The number of winding turns was set to 7, and the diameter of winding wire was set to 0.6 mm.

The measured permeabilities were then evaluated in accordance with the following evaluation criteria. The evaluation results are presented in Table 2. Note that, the reference value in the following evaluation criteria is a value set for each soft magnetic material. For crystalline material, the reference value is the permeability of a molded article produced using the soft magnetic powder of Sample No. 21. For amorphous material 1, the reference value is the permeability of a molded article produced using the soft magnetic powder of Sample No. 25. For amorphous material 2, the reference value is the permeability of a molded article produced using the soft magnetic powder of Sample No. 26.
A: The measured value of the permeability is 115% or greater of the reference value
B: The measured value of the permeability is 110% or greater and less than 115% of the reference value
C: The measured value of the permeability is 105% or greater and less than 110% of the reference value
D: The measured value of the permeability is 100% or greater and less than 105% of the reference value
E: The measured value of the permeability is 95% or greater and less than 100% of the reference value
F: The measured value of the permeability is less than 95% of the reference value

### 7.4. Iron Loss of Molded Article

The iron losses of the molded articles prepared in the same manner as in 7.1. were measured. The iron losses were measured under the following conditions.
Measurement Device: BH analyzer SY-8258 available from Iwatsu Electric, Co., Ltd.
Measurement Frequency: 900 kHz
Number of Winding Turns: 36 turns on primary side, 36 turns on secondary side
Diameter of Winding Wire: 0.5 mm
Maximum Magnetic Flux Density: 50 mT

The measured iron losses were then evaluated in accordance with the following evaluation criteria. The evaluation results are presented in Table 2. Note that, the reference value in the following evaluation criteria is a value set for each soft magnetic material. For crystalline material, the reference value is the iron loss of a molded article produced using the soft magnetic powder of Sample No. 21. For amorphous material 1, the reference value is the iron loss of a molded article produced using the soft magnetic powder of Sample No. 25. For amorphous material 2, the reference value is the iron loss of a molded article produced using the soft magnetic powder of Sample No. 26.
A: The measured value of iron loss is less than 85% of the reference value
B: The measured value of iron loss is 85% or greater and less than 90% of the reference value
C: The measured value of iron loss is 90% or greater and less than 95% of the reference value
D: The measured value of iron loss is 95% or greater and less than 100% of the reference value
E: The measured value of iron loss is 100% or greater and less than 105% of the reference value
F: The measured value of iron loss is 105% or greater of the reference value

TABLE 2

| | | Composition of Insulator-Coated Soft Magnetic Powder | | | | | | |
|---|---|---|---|---|---|---|---|---|
| | | | | | | | | Insulating |
| | | Soft Magnetic Powder | | | | | | Coating Film |
| | | Soft | Average | Specific | Oxygen | | | Hydrophobic |
| | | Magnetic | Particle | Surface | Content | Ratio | Average | Functional |
| Sample | | Material | Size | Area S | A | A/S | Circularity | group |
| No. | Categorization | — | μm | m²/g | ppm | — | — | — |
| 1 | Example | Crystalline | 9.9 | 0.23 | 1260 | 5478 | 0.82 | Alkyl Group |
| 2 | Example | Crystalline | 9.5 | 0.25 | 1520 | 6080 | 0.85 | Alkyl Group |
| 3 | Example | Crystalline | 7.2 | 0.34 | 3120 | 9176 | 0.80 | Alkyl Group |
| 4 | Example | Crystalline | 12.3 | 0.18 | 3167 | 17594 | 0.86 | Alkyl Group |
| 5 | Example | Crystalline | 13.5 | 0.36 | 4350 | 12083 | 0.75 | Alkyl Group |
| 6 | Example | Crystalline | 9.5 | 0.25 | 1520 | 6080 | 0.85 | Alkyl Group |
| 7 | Example | Crystalline | 9.5 | 0.25 | 1520 | 6080 | 0.85 | Alkyl Group |
| 8 | Example | Crystalline | 9.5 | 0.25 | 1520 | 6080 | 0.85 | Alkyl Group |
| 9 | Example | Crystalline | 5.6 | 0.55 | 4200 | 7636 | 0.76 | Cyclic Ether |
| | | | | | | | | Group |
| 10 | Example | Crystalline | 9.5 | 0.25 | 1520 | 6080 | 0.85 | Phenyl Group |
| 11 | Example | Crystalline | 4.5 | 0.36 | 2500 | 6944 | 0.81 | Phenyl Group |
| 12 | Example | Crystalline | 9.3 | 0.25 | 1520 | 6080 | 0.85 | Fluoroalkyl |
| | | | | | | | | Group |
| 13 | Example | Crystalline | 9.3 | 0.25 | 1520 | 6080 | 0.85 | Fluorophenyl |
| | | | | | | | | Group |
| 14 | Example | Crystalline | 10.0 | 0.36 | 1800 | 5000 | 0.70 | Alkyl Group |
| 15 | Example | Amorphous 1 | 3.2 | 0.50 | 3200 | 6400 | 0.76 | Alkyl Group |
| 16 | Example | Amorphous 1 | 24.3 | 0.09 | 280 | 3111 | 0.95 | Alkyl Group |
| 17 | Example | Amorphous 2 | 16.0 | 0.42 | 2650 | 6310 | 0.95 | Alkyl Group |
| 18 | Example | Amorphous 2 | 24.5 | 0.12 | 450 | 3730 | 0.78 | Alkyl Group |
| 19 | Comparative | Crystalline | 32.0 | 0.05 | 560 | 11200 | 0.78 | Alkyl Group |
| | Example | | | | | | | |
| 20 | Comparative | Crystalline | 1.8 | 0.70 | 5800 | 8286 | 0.54 | Alkyl Group |
| | Example | | | | | | | |
| 21 | Comparative | Crystalline | 24.6 | 0.04 | 150 | 3750 | 0.75 | Alkyl Group |
| | Example | | | | | | | |
| 22 | Comparative | Crystalline | 2.2 | 0.65 | 1860 | 2682 | 0.65 | Alkyl Group |
| | Example | | | | | | | |
| 23 | Comparative | Crystalline | 4.5 | 0.36 | 7800 | 21667 | 0.93 | Alkyl Group |
| | Example | | | | | | | |
| 24 | Comparative | Crystalline | 9.8 | 0.44 | 1200 | 2727 | 0.61 | Alkyl Group |
| | Example | | | | | | | |
| 25 | Comparative | Amorphous 1 | 23.5 | 0.12 | 170 | 3417 | 0.92 | Alkyl Group |
| | Example | | | | | | | |
| 26 | Comparative | Amorphous 2 | 22.0 | 0.45 | 1151 | 2538 | 0.76 | Alkyl Group |
| | Example | | | | | | | |

| | Composition of Insulator-Coated Soft Magnetic Powder | | | | | | | |
|---|---|---|---|---|---|---|---|---|
| | Insulating Coating Film | | | | | | | |
| | | Number | | | Evaluation Result | | | |
| | | of Carbons | | | | Radial | | |
| | | in Alkyl | Coverage | Water | | Crushing | Perme- | Iron |
| Sample | Compound | Group | Ratio | Content | Density | Strength | ability | Loss |
| No. | — | — | % | ppm | — | — | — | — |
| 1 | D-1 | 1 | 70 | 119 | A | A | A | A |
| 2 | D-1 | 1 | 85 | 105 | A | A | A | A |
| 3 | D-1 | 2 | 65 | 189 | A | A | B | A |
| 4 | D-1 | 1 | 105 | 86 | A | A | C | B |
| 5 | D-2 | 3 | 80 | 80 | B | B | B | B |
| 6 | D-2 | 3 | 80 | 80 | A | A | A | A |
| 7 | D-3 | 6 | 60 | 90 | A | A | B | A |
| 8 | D-4 | 8 | 55 | 320 | C | C | C | A |
| 9 | A-6 | — | 90 | 90 | B | B | B | A |
| 10 | A-1 | — | 75 | 80 | A | A | A | A |
| 11 | A-1 | — | 70 | 100 | A | A | A | A |
| 12 | B-1 | — | 80 | 75 | A | A | A | A |
| 13 | C-1 | — | 80 | 60 | A | A | A | A |
| 14 | D-1 | 1 | 60 | 289 | C | C | C | B |
| 15 | D-1 | 2 | 80 | 350 | C | B | C | A |
| 16 | D-1 | 1 | 120 | 45 | A | C | B | C |
| 17 | D-2 | 2 | 120 | 50 | A | A | A | E |
| 18 | D-1 | 1 | 90 | 60 | B | B | C | C |
| 19 | D-1 | 2 | 60 | 20 | E | D | A | E |
| 20 | D-1 | 1 | 40 | 450 | F | F | F | A |
| 21 | D-1 | 2 | 60 | 20 | A | E | — | — |
| 22 | D-2 | 2 | 50 | 350 | F | E | D | A |
| 23 | D-2 | 2 | 80 | 600 | E | B | F | A |
| 24 | D-2 | 2 | 45 | 550 | E | E | C | A |
| 25 | D-1 | 1 | 80 | 60 | A | E | — | — |
| 26 | D-1 | 1 | 60 | 85 | C | E | — | — |

As presented in Table 2, it was found that compared to the insulator-coated soft magnetic powders of Comparative Examples, the insulator-coated soft magnetic powders of Examples were able to yield molded articles having a higher density, higher radial crushing strength, and higher permeability. In particular, it was found that even when the specific surface area S was large, the radial crushing strength was able to be increased because of the optimization of the ratio of the oxygen content A to the specific surface area S. It was also found that the insulator-coated soft magnetic powders of Examples could be used to produce molded articles having low iron loss.

What is claimed is:

1. An insulator-coated soft magnetic powder comprising:
a soft magnetic powder; and
an insulating coating film covering the particle surface of the soft magnetic powder and containing a compound having a hydrophobic functional group derived from a coupling agent, wherein
the soft magnetic powder has an average particle size of from 2.0 μm to 25.0 μm,
the soft magnetic powder has a specific surface area of from 0.05 m²/g to 0.60 m²/g, and
a ratio A/S is from 3000 to 20000, where S [m²/g] is the specific surface area and A [ppm] is the oxygen content of the soft magnetic powder.

2. The insulator-coated soft magnetic powder according to claim 1, wherein the oxygen content A in the soft magnetic powder is from 200 ppm to 5000 ppm.

3. The insulator-coated soft magnetic powder according to claim 1, wherein the hydrophobic functional group is a hydrocarbon group.

4. The insulator-coated soft magnetic powder according to claim 3, wherein the hydrocarbon group is a linear alkyl group having from 1 to 6 carbons.

5. The insulator-coated soft magnetic powder according to claim 1, wherein the hydrophobic functional group is a cyclic structure-containing group.

6. The insulator-coated soft magnetic powder according to claim 1, wherein the insulating coating film has a coverage ratio of from 20% to 120%.

7. The insulator-coated soft magnetic powder according to claim 1, wherein a molded article produced using the insulator-coated soft magnetic powder has a radial crushing strength of 10 MPa or greater, the molded article being produced by mixing the insulator-coated soft magnetic powder with 2 mass % of an epoxy resin, and subjecting the resulting mixture to press-molding at a pressure of 294.2 MPa and then heating at 150° C. for 30 minutes to cure the epoxy resin.

8. The insulator-coated soft magnetic powder according to claim 1, wherein the insulator-coated soft magnetic powder has a water content measured at 250° C. by the Karl Fischer method of from 30 ppm to 500 ppm.

9. A magnetic powder core comprising the insulator-coated soft magnetic powder according to claim 1.

10. A magnetic element comprising the magnetic powder core according to claim 9.

11. An electronic device comprising the magnetic element according to claim 10.
